(19) United States
(12) Patent Application Publication
(10) Pub. No.: US 2013/0006743 A1
(43) Pub. Date: Jan. 3, 2013

(54) Method and Apparatus for In-Application Deals

(75) Inventors: Matthew Paul Moore, San Francisco, CA (US); Damon Willis Grow, San Francisco, CA (US); Alex Xu Han, San Francisco, CA (US)

(73) Assignee: CROWDMOB, INC., San Francisco, CA (US)

(21) Appl. No.: 13/528,535

(22) Filed: Jun. 20, 2012

Related U.S. Application Data
(60) Provisional application No. 61/503,320, filed on Jun. 30, 2011.

(51) Int. Cl. G06Q 30/02

(52) U.S. Cl. 705/14.26; 705/14.58

(57) ABSTRACT

A computer-implemented method for in-application advertising display on a second computer using a first computer. A request is received on a first computer to display an advertisement on a second computer, the request from the second computer and including an identification of an application and a location information. The first computer selects an advertisement containing a deal comprised of a discount for prepurchase from a first company and a reward from a second company. The second company is selected based on the identification of the application and the selection is based on both the identification of the application and the location information. The first computer transmits the advertisement to the second computer. The first computer receives a signal from the second computer indicating a purchase of the deal by a user of the second computer.

### RELATED CASES

This is a non-provisional application of provisional application Ser. No. 61/503,320 by Moore et al., filed 30 Jun. 2011, entitled “Method and Apparatus for In-Application Deals”.

### BACKGROUND

1. Field

This disclosure is generally related to in-application advertising and incentive deal offerings.

2. Related Art

Coupons have been used in the United States since the turn of the 20th century, e.g. $0.20 off a purchase or buy-one-get-one free. In the 1980's, airlines popularized loyalty programs in the form of frequent flier programs. Cross-promotions, particularly in the form of an advertiser-sponsored model, have been done online. For example, get 10 Company X game credits if you apply for a mortgage or sign up for a DVD rental service.

More recently, companies such as LivingSocial and Groupon have popularized pre-purchased, group-buying discounts, e.g. prepay $50 to get $100 worth of services. The group-buying model is highly dependent on deep discounts and does not easily integrate with games or other applications.

### BRIEF DESCRIPTION OF THE FIGURES

FIG. 1 shows an architectural level schematic of a system in accordance with an embodiment.

FIG. 2 is a process flow diagram for the deal placement, display and purchase flow in accordance with an embodiment.

FIG. 3 is a process flow diagram for the deal redemption flow for a user in accordance with an embodiment.

FIG. 4 is a process flow diagram for the deal redemption flow for a store in accordance with an embodiment.

FIG. 5 is a process flow diagram for the deal redemption flow for a store in accordance with an embodiment.

FIGS. 6-18 show a user interfaces in accordance with various embodiments.

### DETAILED DESCRIPTION

### Overview

The discussion is organized as follows. First, an introduction describing some of the problems addressed by various embodiments will be presented. Then, a high level description of one embodiment will be discussed at an architectural level. Next, the user interface used by some embodiments will be discussed in conjunction with the details of algorithms used by some embodiments. Lastly, various alternative embodiments are discussed.

Currently a company wishing to advertise a pre-purchased deal that is more modest—or simply outside the box of the deeply discounted group-buying model—faces multiple challenges. Those issues are further compounded if the advertising is targeted for in-application—especially mobile—display where you are competing for the user's attention with their primary task, e.g. reading the news or playing a game. Further, while the discussion and the examples will primarily be couched in terms of pre-paid deals, embodiments can also support coupons and similar offers, e.g. 10% off (without a purchase), buy-one-get-one free, and the like.

Therefore, for example, a 10% discount standing alone may be inadequate to induce a pre-purchase. An in-application advertising system, model and apparatus that provides a framework to present deals to consumers is needed. The approach can use a secondary inducement, e.g. in game rewards, to sweeten the original company's deal. Thus, instead of just getting 10% off your brand X purchase, you might get 10% off (by paying $9 for $10 of credit) and also get, for example, 10 units of in-application—often a game—currency. This means that the advertising has been customized to a specific application. The in-application reward could take other forms, e.g. an extended subscription, extra items, extra capabilities.

Having purchased the deal, a second issue now arises: easy redemption and usage. Particularly if the advertising is location-sensitive, then the user may have just been induced to try a new café or restaurant near their present location, so methods for easily using or redeeming their pre-purchased credit are required as well. The examples and discussion focus on location-sensitive embodiments; however, embodiments can support national and/or general advertising and deal approaches that are not linked to a specific location and/or are used when location information is unavailable.

We describe a system and various embodiments to provide and manage in-application deals. This enables companies to use the system to automatically set up deals for consumers, and for consumers to easily purchase and use those deals. Also, the retail-facing aspects of the system are described, including improvements for rapid redemption and anti-fraud mechanisms associated with the redemption process.

Still other embodiments may use game-like mechanisms to encourage repeat purchases by users and/or social distribution of deals. Two such examples are discussed here. In some embodiments, deals may be targeted to build loyalty with an individual user. For example, on week 1 get $10 for $9 plus 10 credits in the application, on week 2 get $20 for $17 but 30 credits in the application, on week 3 having spent more than $40 total you might be rewarded with the opportunity to buy up to $50 worth of credit at a 15% discount. Such rewards can be based on total purchases at the store, total purchases of deals, and/or total value of purchased deals. The rewards can also take the form of a fixed dollar amount, e.g. $25 next time you buy at least $50 of credit. Additionally, these loyalty rewards may have expiration dates. For example, in one embodiment, in order to get the further discount the user must reach a certain level of purchases within a fixed time period, e.g. 30 days, 90 days, or longer. This can provide retention incentives to customers to return to meet the loyalty tiers or lose the follow on opportunity.

In another embodiment, an offer that was open during week 1 to any user might be forward-able by users who purchased to offer to their friends. So in week 1, user 1 purchases a 20% discount at Macy's deal, pays $40 to get $50 of money to spend—and, optionally, additional in-application rewards. Later, say in week 2, after the offer is no longer widely available, user 1 can forward the offer to their friends, e.g. user 2. If user 2 buys the deal, then user 1 gets an additional reward, e.g. an additional amount, either in percentage or fixed dollar amounts, added to their stored value, e.g. user 1 now has $52 on their stored value if user 2 purchases. The amount of re-distribution allowed and the maximum additional reward can be limited by the system operator and the advertiser. In some embodiments, user 2 may also be eligible to forward the offer for similar rewards.

### System Overview

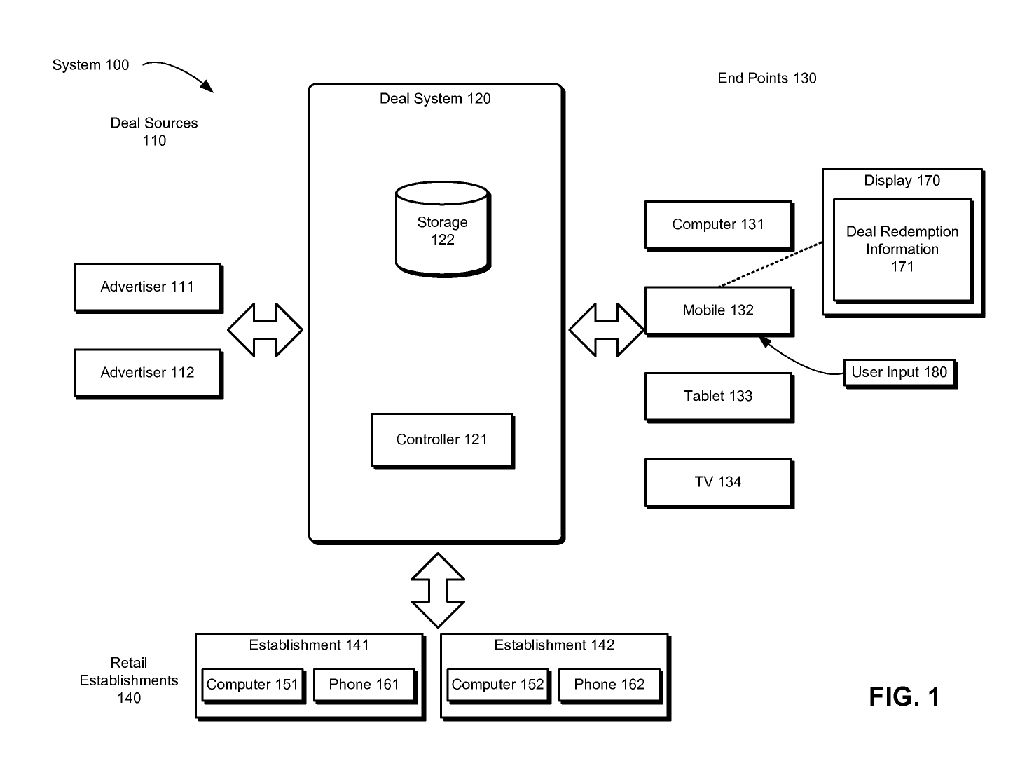

A system and processes to provide and manage in-application deals are described. The system will be described with reference to FIG. 1 showing an architectural level schematic of a system in accordance with an embodiment. Because FIG. 1 is an architectural diagram, certain details are intentionally omitted to improve the clarity of the description. The discussion of FIG. 1 will be organized as follows. First, the elements of the figure and their interconnections will be described. Then, the use of the elements in the system will be described in greater detail.

FIG. 1 includes a system 100. The system 100 includes deal sources 110, a deal system 120, end points 130, and retail establishments 140. The deal sources 110 include advertiser 111 and advertiser 112. Note that the advertisers 111-112 correspond more specifically to computing devices. The retail establishments 140 include the establishment 141 and the establishment 142. These correspond to physical retail establishments, e.g. the coffee shop at 123 Main Street, Anycity, USA. Each establishment 141-142 includes a respective computer 151-152 and a respective phone 161-162. In some embodiments, an establishment, e.g. establishment 142, need only have a phone. The deal system 120 provides a mechanism in such embodiments for over-the-phone redemption using touch-tone interactive systems, or optionally, voice recognition and/or live operators. This may be particularly useful for small establishments without computerized cash registers that wish to offer deals, e.g. food truck, mall kiosk. The retail establishments 140 and the deal sources 110 are interconnected in a business or legal sense. For example, the advertiser 111 might be the corporate parent of the retail establishment 141. Or the advertiser 112 might be acting on behalf of a small business, such as establishment 142, to help promote business. Those relationships are not directly shown in FIG. 1.

Further, although this discussion and the examples are described focused on location-based advertising opportunities, more general advertising such as offers for consumer packaged goods sold at multiple retail establishments can be supported. For example, one promotion might include integration with an existing rewards program, e.g. Coke Rewards, using things like application context, location, and related information (temperature, time of day), to further promote a specific product. Additionally, while two specific redemption flows are described other flows can be supported by embodiments. For example, flows that make use of near field communications (NFC), or “bumps”, could be used to make redemptions. Lastly, on a general note regarding FIG. 1, the publishers and any computers and systems operating under their direction are omitted, they may be a separate party from the deal sources 110 and the retail establishments 140.

Returning to the elements of the diagram, the deal system 120 includes a controller 121 and a storage 122. The primary interconnection is the communications in the form of networked data—and optionally phone—for communication between the deal system 120 and the following: deal sources 110, end points 130, and retail establishments 140. The communications paths are represented by double-headed lines with arrows at both ends. The end points 130 include computer 131, mobile 132, tablet 133, and TV 134. Mobile 132 includes a display 170 showing a deal redemption information 171 generated by the deal system 120 in accordance with one embodiment. Additionally, user input 180 to the mobile 132 is shown.

Having described the elements of FIG. 1 and their interconnections, the elements of the system will now be described in greater detail. The advertisers 111-112 correspond to computing devices (e.g. desktops, laptops, mobiles, tablets) that one or more individuals can use with a web browser, or a dedicated application, to set up deals, define advertising to promote the deals, review the status of their deals, and/or see a dashboard. A single entity may be permitted to have multiple computing devices, e.g. advertisers 111-112, in communication with the deal system 120, e.g. executives can access a dashboard while the art department uploads advertisements and the marketing department controls the financial contents of and display of deals to customers.

The deal system 120 may be composed of multiple computing and storage systems (as well as communications equipment not shown). More specifically, controller 121 and storage 122 can be composed of one or more computers and computer systems coupled in communication with one another. They can also be one or more virtual computing and/or storage resources. For example, controller 121 may be an Amazon EC2 instance and the storage 122 an Amazon S3 storage. Other computing-as-service platforms such as Force.com from Salesforce, Rackspace, or Heroku could be used rather than implementing the deal system 120 on direct physical computers or traditional virtual machines. Communications between the potentially geographically distributed computing and storage resources comprising the deal system 120 are not shown. Also not shown, but capable of inclusion as part of the controller 121 or coupled in communication therewith, is the equipment to receive and process phone calls from retail establishments 140. Platforms such as the Tellme voice response platform from Microsoft that uses standardized languages such as VoiceXML to accept and process calls could be used in some embodiments. Similarly, systems such as Twilio which provide an API for building communication applications could be used. Alternatively, traditional interactive voice response system hardware could be included as part of the controller 121. In still other embodiments, one or more call centers may answer calls and then use a computerized interface to input information into the deal system 120, not shown. Additional embodiments can support other redemption inputs, e.g. bar codes, QR codes, and the like.

The end points 130 are coupled in communication to the deal system 120 (indicated by double-headed line with arrows at both ends). This communication is generally over a network such as the internet, inclusive of the mobile internet via protocols such as EDGE, 3G, LTE, WiFi, and WiMax. The end points 130 may communicate with the deal system 120 using HTTP/HTTPS protocols and may be implemented in one embodiment using a web interface or application to enable easy support of a range of end point device types. As a generic grouping, all of the end point types can be referred to as computers. The mobile 132 can be any mobile device with suitable data capabilities and a user interface, e.g. iPhone, Android phone, Windows phone, Blackberry. The tablet 133 can be any tablet computing device, e.g. iPad, iPod Touch, Android tablet, Blackberry tablet. The TV 134 can be a TV with built-in web support, for example Boxee, Plex or Google TV built-in, or can be a TV in conjunction with an additional device (not shown and often referred to as a set-top box) such as a Google TV, Boxee, Plex, Apple TV, or the like. The display 170 is coupled in communication with the mobile 132, and is capable of receiving user input 180, e.g. via keyboard, mouse, trackpad, touch gestures (optionally on display 170). Other embodiments may support end points such as set-top boxes, e.g. cable or satellite; gaming consoles, e.g. XBOX, PlayStation, or Wii.

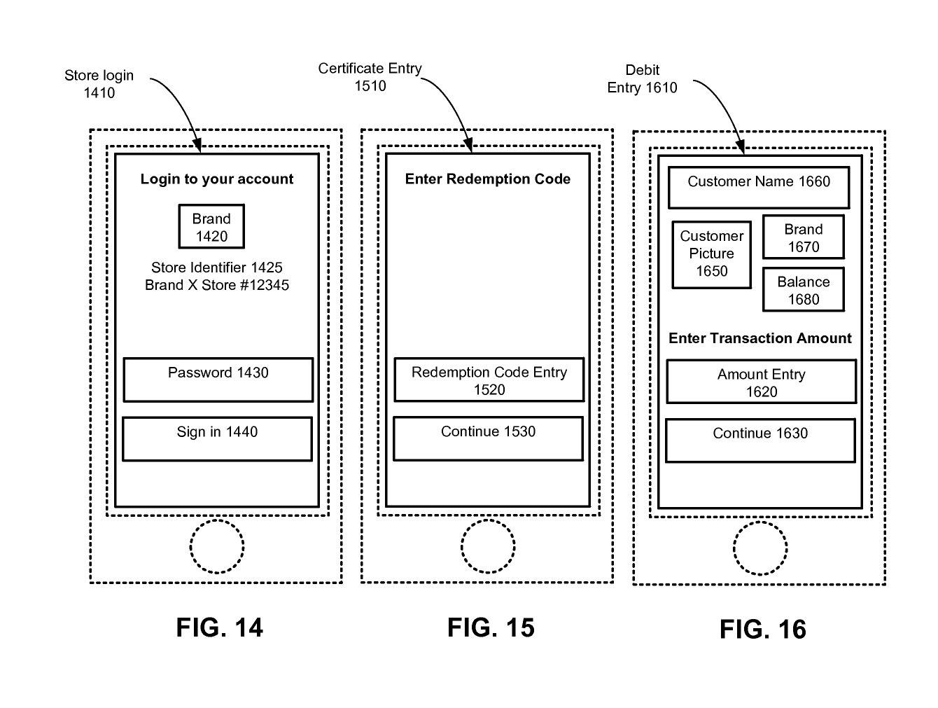

The computers 151-152 in the establishments 141-142, respectively, are any type of computer. In the embodiments shown in FIGS. 14-18, a mobile, of the same type described for mobile 132, is used. In other embodiments, dedicated computerized cash registers or general-purpose computers can be used. For example, in another embodiment they are tablets; still other embodiments make use of other computing devices. The phones 161-162 in the establishments 141-142, respectively, are standard telephones such as a landline (sometimes called “POTS”) phone, VoIP phones, or even a mobile phone. The distinguishing characteristic of relevance in this discussion is the mode of communication with the deal system 120. The computers 151-152 use data communications, e.g. HTTP/HTTPS over a network such as the internet to the deal system 120, whereas the phones 161-162 use audio signals over a phone network to the deal system 120. The communications from the computers 151-152 can be processed digitally while the communications from the phones 161-162 require additional functionality, e.g. in the controller 121 or elsewhere in the deal system 120, to perform touch tone recognition and/or voice recognition and interactions.

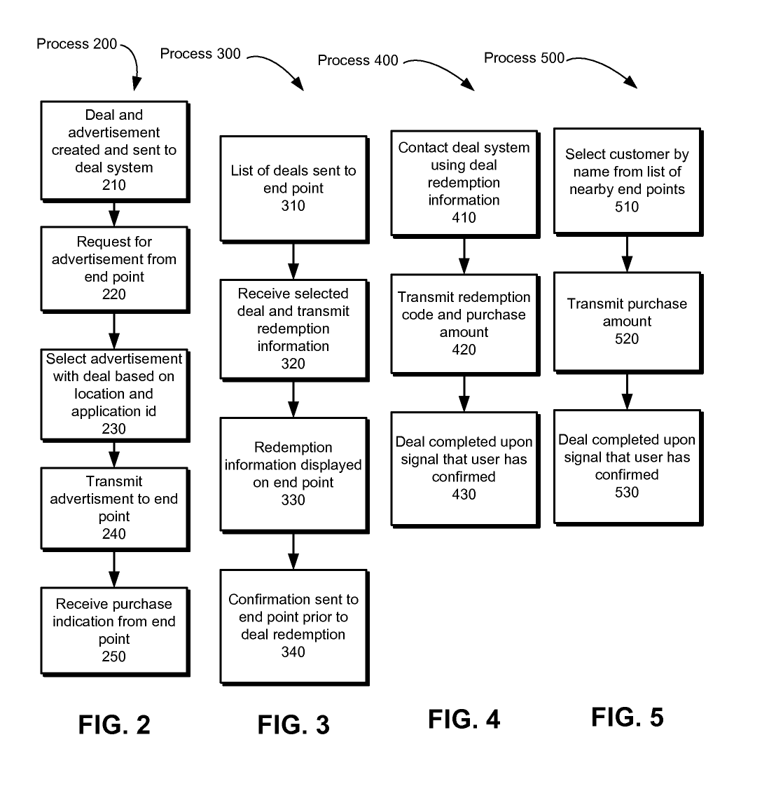

Having described the elements of FIG. 1 and their interconnections and their basic use, the system will be described in greater detail in conjunction with FIGS. 2-5 which provide process flow diagrams for several of the processes of the system.

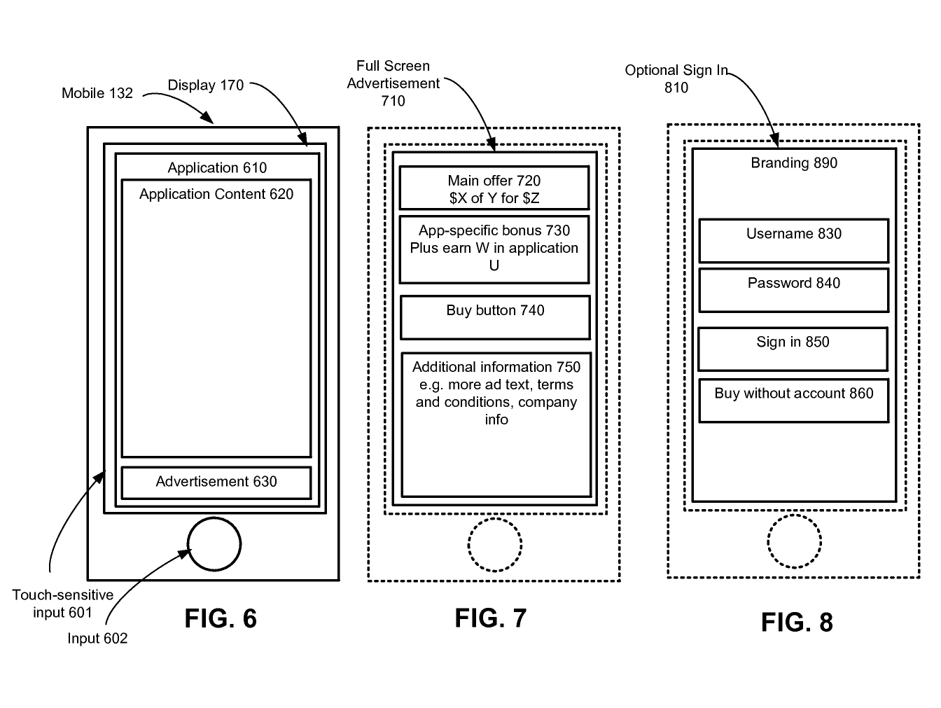

FIG. 2 is a process flow diagram for the deal placement, display and purchase flow in accordance with an embodiment. This process flow diagram highlights the key features of the deal system 120, with more details provided in conjunction with the embodiments discussed with respect to FIGS. 3-5, as well as the embodiments shown with the user interfaces of FIGS. 6-18.

The process starts at step 210 with a deal and advertisement being created and sent to the deal system 120. In one embodiment, the deal system 120 provides a web-based interface using the controller 121 for the advertisers, e.g. advertisers 111-112, to upload these advertisements and deals to the storage 122 for step 210.

The advertisement may take the form of one or more audiovisual elements. One common embodiment for the advertisement is a display graphic in one or more sizes, e.g. banner or full screen, to induce users to purchase a deal. Similarly other formats such as an offer wall, e.g. a list of multiple deals, can be used. Note that the advertisements and the deals, while connected, can be distinct items. For example, a “Shop at Macy's for Less” banner advertisement designed to be at the bottom of a mobile gaming application might be associated with multiple different deals, e.g. 10% off, 20% off. That banner advertisement might then be linked to one or more different full-page advertisements that are more closely linked to the specific deal. In some instances, some or all of the advertisement may be dynamically generated by the deal system 120. For example, the advertisement might be populated with information about the user or the specifics of a deal, e.g. “As a 1K Member of Mileage Plus(R), enjoy . . . ” or “Sarah enjoy 15% off . . . ” In the same vein, the user's social graph and recommendations can be used, e.g. “Your friend Mike enjoyed . . . ”

Note that in one embodiment, the ordering of items for an offer wall may be determined based on conversion rates together with end point-specific user rates. For example, on a TV 134, the top offer may be the most selected while on a mobile 132, the middle offer may be the most selected. Therefore, the deal system 120 may put the offers with the highest conversion rates in those top spots while putting other less commonly selected deals in other locations, or off screen, such that the user must scroll to see the deal.

Continuing at step 220, there is a request for an advertisement from an end point in the end points 130, e.g. mobile 132, received at the deal system 120. The deal system 120 is optimized according to one embodiment for mobile, in-application advertisement placement and deals. Accordingly, in this embodiment, the request from the mobile 132 will at least include location information and an identification of the requesting application. Other items that could be included—or referenced by the deal system 120—include social graph data, social networking data, additional application context, device identifier (e.g. UDID). The location information may take multiple forms, e.g. latitude and longitude, but could also be in the form of a place, check in location, or address, or a combination thereof. Place, or check in location, information may provide better targeting capabilities. For example, in urban locations there may be dozens of retail businesses in a single tall building; however, place information such as “at the food court” or “at the McDonald's” in the building may be more useful in targeting the advertisement. In some cases location information may be unavailable, e.g. location disabled in a specific application and/or no appropriate signals. In these instances, the selection process can according to one embodiment, treat the absence of location information as a signal to select more generalized or national deals as opposed to location, targeted deals.

The application identifier is used because according to one embodiment, the deals are customized to provide an incentive linked to the application. Thus, knowing that you are playing Mob Empire from CrowdMob is important as compared to knowing that you are using the New York Times application. Further, in some embodiments distinguishing between two applications from the same company is relevant. For example, The New York Times Company owns both the The International Herald Tribune and The New York Times. Knowing which of those two is being read is relevant. This is a contrast from, or in some embodiments in addition to, the traditional information available in web-based advertising where an HTTP request (and thus advertising requests) may include information such as IP address (for mobile devices only loosely coupled to location), the platform being used (e.g. Safari on a Mac, or Google Chrome on an Android phone), and the requesting URL.

This information—as well as for registered users, their social graph information (e.g. from Facebook, Twitter, Google, and other sites)—can provide for better targeting of advertisements. The selected deal, see step 230, can be based on the conversion ratio for deals for customers like the one receiving the display as well as filtering (e.g. collaborative filtering) to match taste data between you and other users based on time, location, application context, to select deals with higher likelihoods of conversion at step 220-230.

At step 230, the controller 121 in the deal system 120 selects an advertisement containing a deal using the location information and the application identifier. The deal has two elements according to one embodiment: a discount with the advertiser (e.g. McDonald's, Macy's, Starbucks, United) based on a pre-purchase from that advertiser and a reward from a second company. The second company is selected based on the application identifier. The second company can have a business and/or legal relationship with the operator of the application. For example, the reward may be a cross-promotion to a second brand, so while in the New York Times application, a deal gives you a limited duration free subscription to another New York Times Company property, e.g. the International Herald Tribune. Other approaches might include providing an in game currency specific to the application, e.g. free tokens in Mob Empire from CrowdMob. Still other options include providing an in-application, or in-game, advantage. For example, if Activision/Blizzard wanted to sell advertising in an application, then the deals could provide a small benefit in the game or access to a vanity item for a limited time. Continuing this example, with a massively, multiplayer online game (MMO) like World of Warcraft, the deal might be get $25 at retailer X for $20 and get 24 hours of no repair bills in game. The specific, in-game rewards are defined by the operators of the game and made available to advertisers for a price by way of the deal system 120.

In one embodiment, bidding systems could be used to select the advertisements being shown. However, that is not a required approach. More generally, real-time utilization optimization may provide better results in this context by providing larger discounts for advertisers that approve if we can link that to the current business volume and usage patterns. This in some embodiments can be extrapolated from the redemption levels at a location, e.g. Bob's Florist wants to run a special and as they get more crowded fewer people nearby get offers until redemptions slow and at which point more deals could be offered. Other functionality may include whitelists and/or blacklists, e.g. I do not want my advertisement to run in any games or I as a publisher do not want any competing publications advertised. As mentioned previously, the advertisement selection process can include dynamic customization of the advertisement, e.g. inserting the proper reward, customizing to the user.

More generally, at step 230, the selection can be based on a targeting system that makes use of conversion history (how often this specific deal has been purchased relative the times displayed), filtering to select deals appropriate to the application context (pick context appropriate ads such as “male-oriented” products in a game targeted at and being played by a man vs. “female-oriented” products in an application targeted at and being used by a woman).

With the advertisement selected, at step 240, the advertisement is transmitted to the end point, e.g. mobile 132. In some instances, the end point, e.g. mobile 132, may actually use an HTTP/HTTPS request to retrieve (e.g. cause the transmission of) the advertisement.

On the end point, e.g. mobile 132, the user may be able to interact with the advertisement, e.g. touch, or click, it to expand, or see more details or purchase the offer. Additional details on the purchase flow according to one embodiment are discussed in conjunction with the discussion of FIGS. 7-10. Once the user decides to purchase the deal, then at step 250, the end point, e.g. mobile 132, sends a purchase indication or signal to the deal system 120. For example, in some embodiments, the end point may use an HTTP/HTTPS request with POST data or other parameters to indicate that the purchase has been made. Responsive to this signal, on the deal system 120, the controller 121 can update the storage 122 to reflect purchase of the deal for later use by a user.

In one embodiment, the process of FIG. 2 is implemented in software by one or more libraries or frameworks (e.g. in Objective C (iOS), ActionScript (Flash), Java/Dalvik (Android), Javascript (browsers, Chrome OS), etc.) that communicates with the deal system 120 which in turn is in communication with one or more computers of publishers that are hosting the ads. In that embodiment, step 250, includes transmitting notice of the deal purchase to a publisher. Use of deals is discussed in greater detail in conjunction with FIGS. 4-5 and FIGS. 11-18.

### User Deal Redemption Experience

FIG. 3 is a process flow diagram for the deal redemption flow for a user in accordance with an embodiment. Additional details will also be provided in conjunction with the discussion of FIGS. 11-18.

FIG. 3 includes a process 300 for a user to redeem a deal. The process starts at step 310 on an end point, e.g. from the end points 130 such as mobile 132, with a list of deals sent to the end point. In one embodiment, this process 300 can unfold in a dedicated application, e.g. Mob Deals, on the end point. In other embodiments, a website can be visited on the end point to access the list. The list can be a full list, e.g. all purchased or stored value items that the user has access to based on the records on the deal system 120, or a more selective list based on the user's present location. For example, if the user's purchased deals include Starbucks, McDonald's, and Macy's, but the user is only near a Starbucks, then in one embodiment the controller 121 of the deal system 120 only transmits the Starbucks deal to the phone. In such an embodiment, there may be a “More . . . ” or “All Deals” or similar button in the user interface presented to allow the user to see other deals. See also the discussion of FIG. 11, infra, for further embodiments.

Next, at step 320, an input signal is received on the mobile device, e.g. the user selects one of the displayed deals from the list, and transmitted to the deal system 120. Continuing the example, the user selects a Starbucks deal from their list of deals.

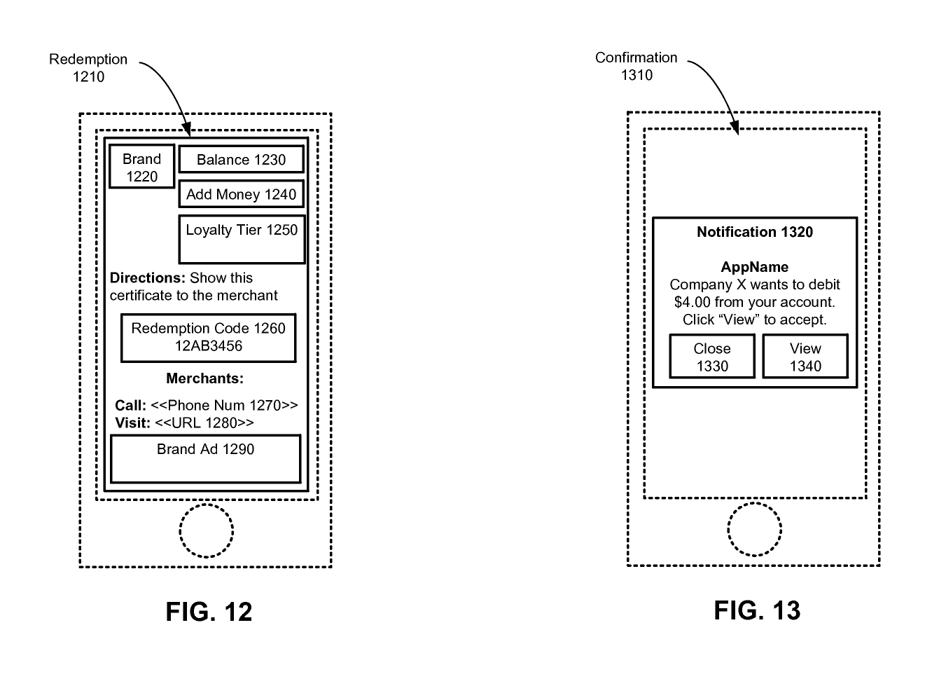

Next, at step 330, the specific redemption information is displayed for making use of the selected deal, e.g. the Starbucks deal in this example. In some embodiments, this display is customized for the specific location of the end point, e.g. selecting a phone number and/or redemption URL customized to the location. For example, at a Starbucks in California, the phone number might be a local 415 area code number, when in New York, a local 212 number, and when in Paris, a local Paris number—in country code 44. Similarly, the redemption URL might be customized for the store, e.g. mobdeals.com/starbucks12345 or mobdeals.com/starbucksnorcal. The redemption code to redeem retail deals can be a short transitory identifier in some embodiments, as opposed to a longer more unique identifier. This embodiment makes it easier to redeem retail deals by making use of close-in-time generation of the redemption code. See the discussion of FIG. 12, infra, for further embodiments. Collectively, the contact information (phone number and/or URL) together with the redemption code can be referred to as redemption information.

As noted previously, the deal system 120 can make use of bar code scanners for the redemption process by displaying a suitably formatted bar code on the end point. In another embodiment, competitive deals could be displayed, for example as the user is reviewing their existing purchased deals (e.g. for Starbucks) a competing offer (e.g. for Peets) could be shown. This may be particularly helpful if the user is not near a Starbucks, but is near a Peets (or vice-versa).

Still other embodiments may make use of a retail establishments existing gift card system. For example, the store may generate a gift card number for each purchaser of deals and that gift card could be displayed. To continue the example, if Safeway has gift cards with 16-digit numbers, every time a deal is purchased (see FIG. 2) as needed, the Safeway computers (not shown in FIG. 1) could provide the deal system 120 a 16-digit number for a gift card to use for the redemption flow. As appropriate the gift cards could be reloaded with value and/or additional ones generated as needed. This may be helpful for retail establishments 140 that have existing gift card processes and redemption technology that they wish to leverage.

Note that the process 300 is described sequentially; however, in some embodiments the steps may overlap or be performed out of order to, for example reduce data transmissions and/or latency. For example, the deal system 120 may both transmit the list of deals (step 310) and the redemption information (step 330) simultaneously to reduce data traffic and/or latency. More generally, the processes of FIGS. 2-5 are all described sequentially but for efficiency some of the steps may overlap or be performed out of order for similar gains.

The final step of process 300 is step 340 with the display of a purchase confirmation. This serves in some embodiments as an anti-fraud measure by requiring the user to confirm that they want to have the dollar amount input by the establishment debited from their pre-purchased value. This can take the form of a notification, dialog box, and/or other forms. In some embodiments, the end point may prompt the user to input a short PIN code or other verification beyond simply pressing an “Ok” or “Confirm” type button. See the discussion of FIG. 13, infra, for further embodiments.

Although step 340 is described as mandatory in the examples, another approach is to omit this step in favor of a notification to the user of purchases, e.g. via push notifications systems, SMS, emails, etc. This may be a less intrusive approach to handling redemptions and provide an after-the fact method for users to dispute transactions. In some embodiments, whether or not step 340 is followed is dependent on factors such as: dollar amount of transaction, e.g. personal limit by user, limit by the retail establishment, or limit by the deal system; user rules; retail establishment rules; and redemption approach. Turning to the first example the system might have a $50 threshold, Starbucks might have a $20 threshold, and/or the user might have a $10 threshold. Thus the lowest threshold present prevails, in this case for a $12.00 purchase, step 340 would occur with the user having to confirm the purchase in advance. Other embodiments allow the retail establishment or the user to require confirmations on all transactions. Similarly, whether process 400 vs. process 500 is being used for redemption might change whether or not explicit confirmation is required. This could reduce any potential problems with accidental selection of the wrong user in process 500.

In still another embodiment, step 340 occurs if the transaction exceeds the stored value amount and allows approval and purchase of additional stored value without having to provide a new payment instrument. This can even work over messaging approaches such as SMS where a reply “Yes” or “Ok” could trigger the balance addition. For completeness, the discussion of process 400 and process 500 will refer to step 340; however, as indicated here the step can be omitted.

### Retail Establishment Deal Redemption Experiences

FIG. 4 is a process flow diagram for the deal redemption flow for a store in accordance with an embodiment and FIG. 5 is a process flow diagram for the deal redemption flow for a store in accordance with another embodiment. They will be described together since they are quite similar. FIG. 4 includes the process 400 and FIG. 5 includes the process 500. The analogously numbered steps, e.g. step 410 and step 510, perform similar functions with different implementations.

Conceptually, process 400 is redemption code driven, e.g. the exact counterpart to FIG. 3 and process 300. Process 500, in contrast, provides an alternative interface for establishments to redeem deals when they have a large number of redemptions.

Process 400 starts at step 410 with a retail establishment in the retail establishments 140 contacting the deal system 120. For example, the establishment 141 could use a computer 151 (e.g. their computerized cash register, the web browser on a cashier's mobile phone) to contact the deal system 120. Alternatively, phone 161 could be used by dialing the phone number provided. In one embodiment, step 410 is responsive to a cashier looking at an end point's display from step 330. For example, the user of mobile 132 could show the redemption information from step 330 (including a URL and/or phone number and/or scanable bar code) to the cashier. The cashier could then access the URL listed or call the phone number provided. In some embodiments, an establishment may have a generic URL or phone number that they use regularly and only make use of the redemption code provided.

At step 420, the redemption code and the amount of the transaction are transmitted. In the computer embodiment, the information can in one embodiment be submitted via a web form. In the phone embodiment, the redemption code could be keyed in via touch-tone or speech recognition and the purchase amount similarly input. See the discussion of FIGS. 14-16, infra, for a further discussion of additional embodiments.

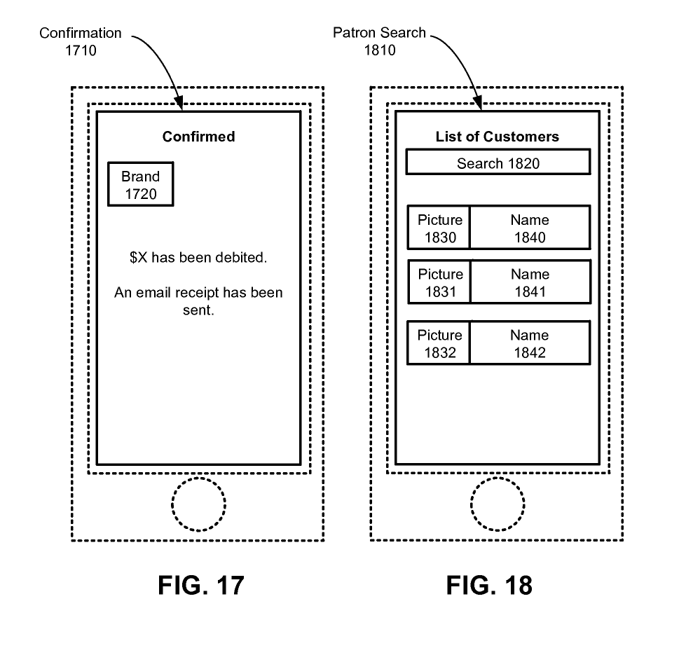

Finally, at step 430, the retail establishment receives confirmation of the successful transaction after the user confirms the deal (e.g. step 340 of process 300). Once the deal system 120 provides confirmation, e.g. transaction id, receipt, email or the like, the retail establishment can take appropriate steps in its check-out process to reflect the credit. See the discussion of FIG. 17, infra, for a further discussion of additional embodiments.

Turning back to FIG. 5, step 510 is a primary point of difference with FIG. 4. Here, the retail establishment is already in communication with the deal system 120, via a computer interface. This provides the establishment 141 a periodically refreshed list of nearby end points, e.g. mobile 132, who have deals for redemption. The list can be by first name, first name with last initial, or the like, e.g. “John D,” “Doe/J,” “John,” and optionally include a user avatar/picture/profile image for easy selection. This approach is secure due to the confirmation process (step 530 paired with optional step 340 of process 300). At step 510, a user is selected from the list.

Next, at step 520, the store transmits the purchase amount to the deal system 120. Finally at step 530, the notification (or confirmation) occurs. Again, steps 520 and 530 are analogous to steps 420 and 430, and those descriptions are applicable. See the discussion of FIG. 18, infra, for a further discussion of additional embodiments.

### User Interfaces for Purchases and Redemptions

FIGS. 6-18 show user interfaces in accordance with various embodiments for both purchases and redemptions of deals. All of these examples make use of a mobile end point, e.g. mobile 132 in end points 130. Mobile 132 is only shown explicitly in FIG. 6; in the remaining figures the dotted lines represent the device. The device used in these examples is a prototypical current generation touchscreen mobile device, such as an iPhone from Apple Computer; however, other mobile devices could be used. Additionally, the user interface depictions are intentionally sparse to focus on key elements in relation to the processes of FIGS. 2-5 that were discussed, supra.

FIG. 6 includes the mobile 132 with the display 170 and two input devices, touch-sensitive input 601 (covering the display) and a button input 602. Turning to the displayed user interface, an application 610 is executing and displaying application content 620, as well as an advertisement 630. The position of the advertisement 630 in the application 610 is determined solely by the application developer. The shape and area of the advertisement 630 may be in the shape of one or more de facto standards, for example 320×50 points, 480×32 points, 768×66 points and 1024×66 points. As noted previously in some embodiments an offer wall format may be used. For smaller than full page ads, the advertisement 630 could be an inducement for the user to engage and view a larger, full screen (or nearly full screen) advertisement 710 as seen in FIG. 7.

In one embodiment, the application 610 could be a game; in another embodiment, the application 610 could be a content application, e.g. The New York Times, The Wall Street Journal, The New Yorker magazine. More generally, it can be any mobile application running on the mobile 132, for example Instagram or Pandora.

Turning to FIG. 7, after the user has interacted with the advertisement 630 (e.g. touch, click, etc.), a full screen advertisement 710 is displayed. A close button (not shown) can allow the user to dismiss the advertisement. The display is described as full screen; however, it need not occupy the full screen. The display space used can be advertising and deal dependent.

The full screen advertisement 710 can be customized to a high degree, but four elements are included according to one embodiment: the main offer 720 ($X of Y for $Z), an app-specific bonus 730 (plus earn W in-application U), a buy button 740, and a region for additional information 750 (more ad text, terms and conditions, company information). The main offer 720 is a region that describes the heart of the deal, e.g. prepurchasing a credit at a store for a discount (for example, $10 of McDonald's food for $9). The app-specific bonus 730 is a region that describes a reward linked to purchase of the offer that is relevant to the application 610, or a sister property or application of application 610. This interrelationship between the reward and the application 610 was discussed in connection with step 230 of process 200 relating to the ad selection process. For example, if the application 610 is Mob Empire, the reward might take the form of tokens; if the application 610 is The New York Times, the reward might take the form of a free subscription period. More generally the reward can take the form of virtual goods, e.g. a super-ragingly angry bird to use a limited number of times in Angry Birds, a special item for your farm in Farmville. The buy button 740 enables the user of the end point device to purchase the offer. The additional information 750 is a region that allows for additional ad text, terms and conditions and the like. A tabbed, scrolling, or expanding interface may be used in one embodiment to allow detailed information to be viewed by the user of the end point.

In FIG. 8, the assumption is that the user has acted on the buy button 740 of FIG. 7 to purchase a deal. FIG. 8 is a sign-in interface, which in one embodiment is optional, with an optional sign in 810 display with suitable branding 890, as well as input areas for username 830, password 840, and a button to sign in 850, together with an option to buy without account 860. As noted, sign in is an optional feature of some embodiments; similarly, if sign in is enabled by default, then users still may be allowed the option to buy deals without an account. In other embodiments, sign in is mandatory and deals cannot be purchased without registration. The frequency of requiring the user to sign in can be customized by the operator of the deal system 120. The specific sign in credentials (username/password vs. biometric, end point trusted platform chip, certificates, near field communications (NFC), etc.) can be modified in different embodiments. Note, that the process can jump from FIG. 7 to FIG. 10 if the publisher of an advertisement has provided authentication—and if the funding source is already known. Also other approaches can be used at FIG. 8 such as Facebook logins, Google ids, and the like. In still other embodiments, the password is separately requested from the username.

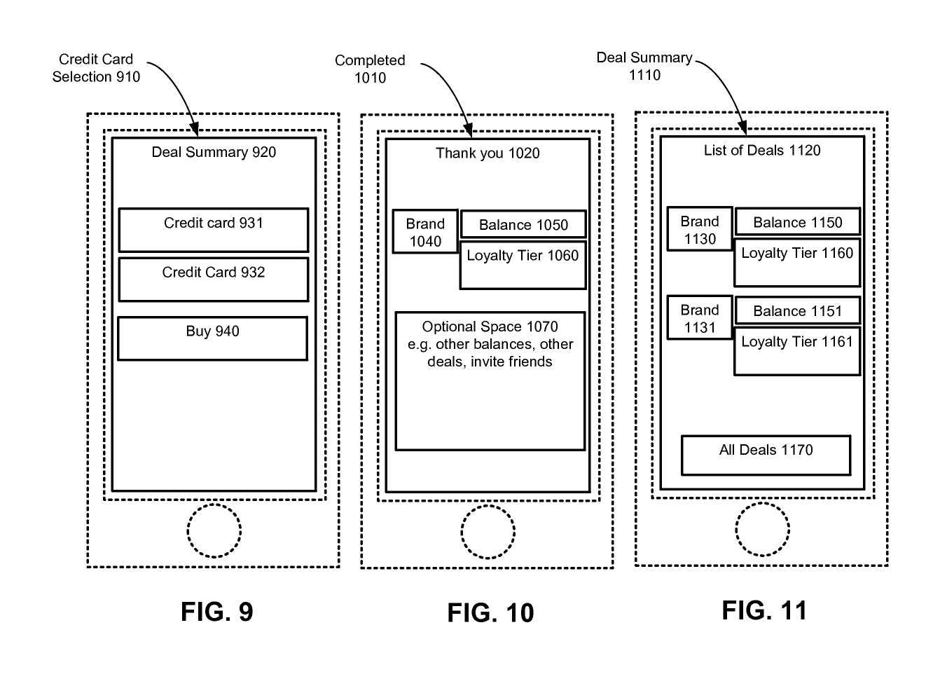

Turning to FIG. 9, after the user has signed in explicitly—or implicitly—the user selects a payment method. In this exemplary embodiment and user interface makes use of credit/debit cards with a credit card selection 910 display. In this embodiment, the deal is re-summarized at the top, deal summary 920, and a list of prior credit cards (credit card 931, credit card 932) is shown to the user. If no credit cards are on file, the user can be prompted to provide a card. In some embodiments, the payment method selection is bypassed if the user has established at least one payment method and FIG. 9 serves as a confirmation screen. Additionally, while the example is focused on credit card entry more payment methods like direct deposit, Paypal, Amazon Checkout, Google Checkout, prepaid cell cards, carrier billing, and the like can be supported. Similarly, the credit card selection 910 display may provide additional interface elements to manage stored credit cards. A buy 940 button is provided to complete the purchase of the deal.

FIG. 10 shows the display after completion of the purchase according to one embodiment. The completed 1010 display includes a thank you or confirmation to the user (thank you 1020), as well as a brief summary of the deal, e.g. branding (brand 1040), the total purchased balance (balance 1050) and information about loyalty tiers (loyalty tier 1060, optional). Additionally, further space (optional space 1070) is available to, for example, invite friends to buy, purchase related deals, see other balances, inducements to use the purchased value, inducements to use the in-application reward.

Some embodiments use game-like mechanisms to encourage repeat purchases by users and/or social distribution of deals. Loyalty tiers are one such mechanism. Loyalty tiers display the cumulative deal purchases with a merchant, e.g. McDonald's, and offer access to a better or additional deal after completing a certain volume of purchases. For example, if 10% off is McDonald's “standard” level of discount, upon reaching a certain volume, say $50, access to a 15% discount for a certain quantity might be available. Various tiers of loyalty could be provided, e.g. one time 15% for a limit of $10 purchased, then after another $50, 20% discount with a limit of $10 purchased, and so on up to a fixed cap. Other embodiments could include a specific amount of stored value in credit, e.g. $25 free with your next purchase—or purchase of $50 or more. Displaying the loyalty information can incentivize users to make additional deal purchases. Similarly, providing expiration to the loyalty rewards can similarly incentivize additional purchases and is used in some embodiments. Other embodiments make use of social networks, or viral distribution. For example if you can get X of your friends to purchase a deal, the merchant provides you extra rewards. For example, if you get 3 friends to buy $10, you get $5 extra.

Continuing to FIG. 11, the context has switched from purchase of deals to redemption of deals. In this embodiment, the deal summary 1110 display is inside of a custom application, e.g. Mob Deals, or a web browser as opposed to the context of FIGS. 6-10 which were implemented inside application 610. The difference being that during the purchase process it was important to remain in the context of application 610 for the user. The list of deals 1120 summarizes the stored purchases on the deal system 120 for the user. In this embodiment, the display provides emphasis for the branded logos of the stored deals (brand 1130, brand 1131), the respective balances (balance 1150, balance 1151) and information about the loyalty tier status (loyalty tier 1160, loyalty tier 1161). In this example, the list shows the location, or context, sensitive deals for the user. An all deals 1170 button is provided in this embodiment to enable the user to see all of their deals. Other embodiments might sort the deals into groups, e.g. “Nearby” and “Other Deals.” Additionally, other embodiments might provide scrolling to enable review of longer lists. The sort order within lists is implementation specific. For example, proximity based on location could be one sorting criteria, as could alphabetical order.

Notably, FIG. 11 highlights that the deal system 120 provides a single interface for a multi-vendor stored value account where there is an intentional prohibition on the transfer of value between the vendors, e.g. you cannot move your Macy's money to McDonald's. Some embodiments may provide a mechanism for users to trade deals, potentially as another deal and perhaps at a penalty, e.g. $1 of Macy's credit can be transferred to McDonald's for $0.75 of credit. Still other embodiments may permit users to sell their credits to others, like gift card exchanges. For example, a services along the lines of third party services for gift card and deal exchanges, e.g. CoupRecoup, DealsGoRound, could be implemented directly within the deal system 120. In one embodiment the operator of the deal system 120 may take a service fee or percentage of the transaction for facilitating the exchange. Additionally, providing the exchange within the platform provides trust between buyers and sellers against fraud as well as preserving easy redemption.

FIG. 12 shows one embodiment of a user interface for the redemption 1210 display. This display can be used at step 330 of process 300 of FIG. 3. In this configuration, the redemption 1210 display is customized for this end point, e.g. mobile 132, with the branding (brand 1220), the current balance (balance 1230), an optional area to add money (add money 1240), and optional information about the loyalty tier (loyalty tier 1250). If money is permitted to be added, which is at the discretion of the retail establishment, it might not be at a discount, e.g. pay $1 for $1 of credit. A redemption code 1260 is displayed, as a short alphanumeric code for the retail establishments 140 to use in redeeming the user's credit. In some embodiments, the codes are intentionally numeric only to allow easier phone submission. In another embodiment, the codes are intentionally designed to be usable for only a short duration (e.g. less than a day or less than an hour), and as such are significantly shorter than might otherwise be used for a unique certificate number, e.g. 4-8 characters versus 10-20 characters. Lastly, spaces for a phone number (phone num 1270) and/or a URL (URL 1280) are available. As discussed in connection with step 330 (see FIG. 3) the phone number and URL may be customized for the end point, location, and/or retail establishment. This can reduce telephone bills for phone redemption, make the correct language available for answers (French for France, German for Germany, English for USA), and provide additional security. Note also, that additional advertising space (brand ad 1290) may be available, e.g. to help the establishment sell items. As discussed previously, bar codes and/or existing store gift code numbers can be used in some embodiments.

FIG. 13 shows one embodiment (specifically adapted for the notifications UI of the iPhone) of the optional in-store purchase confirmation. This corresponds in one embodiment to step 340 (FIG. 3), and is a gate on completion for step 430 and step 530 (FIG. 4 and FIG. 5, respectively) when used. Shown in the form of a confirmation 1310 display (the running application is not shown), a notification 1320 is shown where a specific debit request is made. If the user wishes to confirm the transaction, in this embodiment they must view (view 1340 button) the details and, optionally, hit an additional confirmation button (not shown) once the AppName, e.g. Mob Deals, application launches. In some embodiments, after the user selects view 1340, the user is prompted for additional verification, e.g. short PIN, full password, biometric identification, verification of electronic certificate on the phone, etc. As noted previously, in some embodiments the notification is only used to get permission for additional purchases beyond the stored value via the prior payment method. Thus avoiding the need to use both the code and a second payment method such as a credit card. Thus a $12 for $10 deal where the user wants to spend $13 can use up the entire $10 purchase and prompt for an additional $1. In some embodiments there may be a minimum purchase amount, so the user might end up buying $5 of value and using only $1 leaving an additional $4 balance.

Turning now to the experience for retail establishments, a computer-based implementation is shown. In FIGS. 14-18, a mobile phone, such as the mobile 132, is used as the computer 151. In one embodiment, the interface discussed in FIGS. 14-18 is provided using a general-purpose web browser, e.g. Mobile Safari, Google Chrome, Firefox, on the computer. Additionally, the URL field (not shown), would according to one embodiment, be the URL 1280.

FIG. 14 shows an optional initial login screen (store login 1410) with room for branding (brand 1420), an optional store identifier (store identifier 1425), as well as an optional password (password 1430) entry area and a sign-in button (sign in 1440). As noted, this is only one embodiment; other authentication methods can be used, e.g. IP address, certificates on the computers in the retail establishment. Similarly, the password may be omitted in some embodiments or not require if the password has been provided within a predetermined window on the computer, e.g. at store open by a manager, the login can be omitted. For the phone-based implementations, caller id, automatic number identification (ANI), and/or similar technologies can be used to identify the retail establishment and reduce the need for passwords.

FIG. 15 shows the certificate entry 1510 display. In this embodiment, entry of the redemption code (see redemption code 1260 on FIG. 12) is kept separate from entry of the transaction amount to permit the retail establishment to see more details about the user as shown in FIG. 16. Other embodiments obtain both the redemption code and transaction amount together. In FIG. 15, there is a space for entry of the redemption code (redemption code entry 1520) and a button to continue (continue 1530). FIG. 16 shows the debit entry 1610 display according to one embodiment. In this embodiment, significant information about the redeeming customer, such as their name (customer name 1660), their profile picture (customer picture 1650), and their current balance (balance 1680) are shown together with branding for the current establishment (brand 1670), e.g. a McDonald's logo. The specific information shown may vary based on the embodiment and also, in some embodiments, based on the tier of service the retail establishment has elected. For example, to obtain customer names during redemption may require a higher paid tier of service. Similarly other customer relationship management (CRM) as addresses and email might only be available after a transaction is completed. Once the amount of the transaction is entered (input area for amount entry 1620), a continue button (continue 1630) triggers the user confirmation process according to one embodiment. Other selection methods such as bar code entry, gift card entry, user email, phone #, and/or name may be available in some embodiments. The input area 1620 could be a numeric keypad filling a larger portion of the screen. In such an embodiment, significantly more area of the screen could be provided for amount entry 1620 than is shown in FIG. 16.

The optional user confirmation process was discussed in connection with step 340 (FIG. 3) and also FIG. 13. Once the user has confirmed the transaction, a confirmation 1710 display can be shown to the vendor as illustrated in FIG. 17 together with optional branding (brand 1720) and information. The information can include comments about the user such as from a customer relationship management (CRM) system, e.g. deal system 120 specific or one the retail establishment operates. For example, historical purchase information might be available. In another embodiment, relevant information from the user's social networking sites might be included and shared with the store, e.g. birthday, photo, recent comments, checkins, etc. In some embodiments, the confirmation may be sent via email and/or a transaction identifier, or other information, for the establishment to enter into their cash registers can be provided. Additionally, as noted, the transaction details may also be emailed or automatically transmitted by the deal system 120 to a data warehouse, CRM system, or other repository operated by the retail establishment. In some embodiments, the interfaces of FIG. 15 or FIG. 16 may provide an input field for a cash register or other transaction identifier from the retail establishment, e.g. to enable this transaction to be cross-referenced with the register.

Finally, FIG. 18 shows one exemplary user interface that could be used in connection with step 510 (FIG. 5). In this embodiment, the patron search 1810 display provides a list of nearby end points with pre-purchased stored value on the deal system 120. In this embodiment, a search field (search 1820) is provided to search by name, and the display includes both pictures (picture 1830, picture 1831, picture 1832) and names (name 1840, name 1841, name 1842). The pictures are optional but may be a feature of the deal system 120 to help with security and deter fraud. As discussed previously, the listing of names could be partial, e.g. “John D,” “Doe/J,” or listed out in full. Once the user in the retail establishment clicks on the customer name, the certificate entry of FIG. 15 is avoided, with the flow corresponding to process 500 according to one embodiment using the interfaces of FIG. 16 and then FIG. 17.

In one embodiment, the deal system 120 may require users of mobile end points to take a self-picture using a camera on the end point. Those photos may then be subject to computer and/or human review to verify that they represent a face. In another embodiment, the pictures may be a profile picture from a social networking site or a social network profile linked to the deal system 120.

### Conclusion and Additional Embodiments

We have now described a system and processes that provide and manage in-application deals.

Some additional embodiments and features include:
Some embodiments include social distribution methods such as gifting deals directly to others, e.g. friends. In such an embodiment you can directly send the gift to a friend. In other embodiments the gift can be “dropped” at a specific location for later pickup by the friend. In the latter embodiment, the friend may have a limited time to pick up the deal and/or be presented the deal as a surprise on approaching the location. For example, if you know your friend Marissa regularly visits Starbucks, purchasing a deal that is dropped at her favorite Starbucks might be a nice surprise.
Other location embodiments may include using game mechanics to involve friends in your deal and obtain a reward for yourself. For example, requiring a specific number of your friends to check in or purchase something at a venue to in turn increase your reward level. These requests can, according to some embodiments, be broadcast or published on social networking sites.
In some embodiments, the device identifier (e.g. UDID) is used to target advertising on the deal system 120 and/or to correlate activities and additional data sources from other parties.
In some embodiments, users may provide the deal system 120 access to social network information and/or their social graph. This can be used by the deal system 120 to provide for more focused targeted of deals. For example, users that have checked in regularly at coffee shops might be presented more coffee-themed materials. Similarly, according to some embodiments, competing locations may be selected as well, e.g. Peet's vs. Starbucks using the data.
In some embodiments, applications are assigned one or more genres or tags, e.g. “jock”, “sports”, “game”, “newsie”, “geeky”. Those tags can be used to assist in matching deals and advertisements with applications.

For example, a game targeted at guys would generally be tagged with genres that are inconsistent with showing most pedicure advertisements.
In some embodiments, the advertisement selection is time sensitive in that it is linked to a recent action in the application. For example, clicking on a pair of sunglasses might prompt advertising for Gucci brand sunglasses.
In other embodiments, the integration between the deal system 120 and the applications ensures that the advertising is time sensitive in that it is presented in a fashion that does not interrupt the flow of the game.
In some embodiments if location information is unavailable and/or not provided to the deal system 120, the deal system 120 will select deals that are not geographically targeted, e.g. national deals or deals for stores with large nationwide footprints.
One embodiment can be viewed as a complete system for in application deal presentment, user interaction, and purchase without leaving the underlying application. This unitary flow provides advantages of avoiding context switches that are costly and disruptive. This is especially true in the non-computer end points, which compared to computer end points displaying standard web advertisements have: a smaller screen, more limited input mechanisms (text entry may be harder due to touch or keyboard-less remote control), and less operating system support for multi-tasking. Further even on computer end points, the seamless flow of being able to complete the entire view/present, user interact, and purchase without leaving the underlying application can provide significant advantages for conversion of the offer into a purchase.
Some embodiments support internationalization of displayed deals and advertisements using a mixture of manually created and automatically translated deals and advertisements. In other embodiments, only the user interface is fully internationalized.

Any data structures and code described or referenced above are stored according to many embodiments on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The preceding description is presented to enable the making and use of the invention. Various modifications to the disclosed embodiments will be apparent, and the general principles defined herein may be applied to other embodiments and applications without departing from the spirit and scope of the invention. Thus, the invention is not intended to be limited to the embodiments shown, but is to be accorded the widest scope consistent with the principles and features disclosed herein. The scope of the invention is defined by the appended claims.

What is claimed is:

1. A computer-implemented method for in-application advertising display on a second computer using a first computer, the method comprising:
receiving a request on a first computer to display an advertisement on a second computer, the request from the second computer, the request including an identification of an application and a location information;
selecting an advertisement containing a deal using the first computer, the deal comprised of a discount for prepurchase from a first company and a reward from a second company, the second company selected based on the identification of the application, the selecting based on the identification of the application and the location information;
transmitting the advertisement to the second computer from the first computer; and
receiving a signal from the second computer on the first computer, the signal indicating a purchase of the deal by a user of the second computer.

2. The computer-implemented method of claim 1, further comprising, the request further including one or more of an identification of a user, a device identifier, a social networking identifier, and a demographic data.

3. The computer-implemented method of claim 2, wherein the selecting further comprises:
evaluating on the second computer a loyalty level based on the request; and
modifying the advertisement based on the loyalty level.

4. The computer-implemented method of claim 1, wherein the receiving the request, the selecting the advertisement and the transmitting the advertisement occur at a first time and the method further comprising, at a second time after the first time the receiving the signal occurs.

5. The computer-implemented method of claim 1, wherein the second computer selected from the set comprising a mobile device, a tablet device, a gaming console, a television, and a personal computer.

6. The computer-implemented method of claim 1, wherein the advertisement is automatically internationalized from a first language to a second language based on the request.

7. The computer-implemented method of claim 1, wherein the selecting occurring based on temporally recent information on the first computer about current redemptions of other deals at location offering the deal.

8. The computer-implemented method of claim 7, wherein companies with low redemption rates of other deals have deals selected more often.

9. A computer-implemented method for in-application advertising display on a second computer using a first computer, the method comprising:
receiving a request on a first computer to display an advertisement on a second computer, the request from the second computer, the request including an identification of an application and a location information;
selecting an advertisement containing a deal using the first computer, the deal comprised of a discount for prepurchase from a first company, the selecting based on the identification of the application and the location information;
transmitting the advertisement to the second computer from the first computer; and
receiving a signal from the second computer on the first computer, the signal indicating a purchase of the deal by a user of the second computer.

10. A computer-implemented method for in-application advertising display on a first computer using a second computer, the method comprising:
transmitting a request from a first computer to display an advertisement to a second computer, the request including an identification of an application and a location information, the transmitting occurring within the application;
receiving an advertisement containing a deal using on the first computer from the second computer, the receiving occurring within the application, the deal comprised of a discount for prepurchase from a first company, the selecting based on the identification of the application and the location information;
displaying the advertisement on the first computer within the context of the application;
receiving a first signal on the first computer, the first signal indicating a request to interact with the advertisement;
responsive to the first signal, displaying additional information related to the advertisement and the deal;
receiving a second signal on the first computer, the second signal indicating a request to purchase the deal by a user of the first computer; and
completing the purchase of the deal by the user of the first computer within the context of the application.

11. A computer-implemented method for fraud reduction in deal redemption using a first computer, the method comprising:
receiving on the first computer a message from a second computer, the message indicating a redemption attempt of a stored value associated with a user of the first computer;
prompting the user to approve the redemption; and
responsive to receiving approval, transmitting a second message to the second computer indicating approval, wherein the receiving, prompting and transmitting occur concurrent with the transaction.

12. The computer-implemented method of claim 11, wherein occurring concurrent with the transaction means that the steps occur in under thirty seconds from the time the redemption attempt is initiated on a third computer.

13. The computer-implemented method of claim 11, wherein the redemption attempt fails unless the second message is sent to the second computer.

14. The computer-implemented method of claim 11, wherein the message indicates the redemption attempt is for an amount greater than the stored value and wherein the second message indicates an approval for the second computer to charge the user for at least the difference between the amount and the stored value.

15. The computer-implemented method of claim 11, wherein the redemption attempt fails unless the second message is sent to the second computer.

16. A computer-implemented method for deal sharing using a first computer, the method comprising:
receiving a message on the first computer from a second computer, the message including a location, a request to drop a deal, and one or more recipients, the location corresponding to the physical location of the second computer;
generating at least one message to one of the one or more recipients about the deal and the location for pickup; and
responsive to receiving a second message from a third computer providing the deal to a user of the third computer, the second message including a second location, the second location being within a sufficient proximity to the location to indicate that the third computer is approximately at the location.

17. A computer-implemented method for deal sharing using a first computer, the method comprising:
receiving a message on the first computer from a second computer, the message including a location, a request to drop a deal, and one or more recipients, the location corresponding to a physical location distinct from a current physical location of the second computer;
generating at least one message to one of the one or more recipients about the deal and the location for pickup; and
responsive to receiving a second message from a third computer providing the deal to a user of the third computer, the second message including a second location, the second location being within a sufficient proximity to the location to indicate that the third computer is approximately at the location.
